(19) United States
(12) Patent Application Publication
(10) Pub. No.: US 2008/0198873 A1
(43) Pub. Date: Aug. 21, 2008

(54) VOICE COMMUNICATIONS SYSTEM USING SIP AND METHOD THEREOF

(76) Inventors: Yung-Lang Huang, Taipei City (TW); Tsung-Yu Ma, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/031,710

(22) Filed: Feb. 15, 2008

(30) Foreign Application Priority Data
Feb. 16, 2007 (TW) 096106269

(51) Int. Cl. H04J 3/22

(52) U.S. Cl. 370/466

(57) ABSTRACT

A voice communications system includes a first communications device and a second communications device. The first communications device uses data conforming to a predetermined protocol to perform voice communications. The second communications device uses data conforming to SIP to perform voice communications. The second communications device can convert data from conforming to SIP to the predetermined protocol and vice versa. Thus the second communications device is capable of communicating with the first communications device.

### BACKGROUND OF THE INVENTION

1. Field of the Invention

The present invention relates to a voice communications system, and more particularly, to a voice communications system utilizing Session Initiation Protocol (SIP) to implement voice communications.

2. Description of the Prior Art

Voice over Internet Protocol (VoIP) is implemented by compressing voice and image signals into data packets, and then transmitting the compressed data packets through an internet. A traditional telephone system such as the public switched telephone network (PSTN) system transfers voice signals in different time slots. In early days, the quality of voice signals transferred through the VoIP system is incomparable with those transferred through the PSTN system because of the narrow bandwidth of the VoIP system. However, the quality of voice signals transferred through the VoIP system has dramatically improved with the increased bandwidth of the VoIP system. Over the past years, various network phones and real time communications software programs such as Skype, MSN Messenger, Yahoo Messenger, Google Talk, AIM and ICQ have been developed to make communications easily accessible.

VoIP technology comprises various communications protocols such as H.323, SIP (Session Initiation Protocol) and MGCP (Medium Gateway Control Protocol). SIP is a signal control protocol in the internet application layer for establishing, updating and terminating communications services. SIP defines the commands and standards for establishing and terminating communications. The advantage of SIP is that it is developed mainly for multi-layer and multi-species media communications. SIP can exchange information with PSTN through a gateway. SIP can also be used in a wide area network. Thus SIP is a flexible and powerful communications protocol.

VoIP utilizes an existing network for exchanging voice signals, thus can save a lot of telephone cost. However, there are many communications software programs available on the market, and different communications software programs may employ different communications protocols. Thus VoIP may become unfeasible when two communications ports utilize different communications software programs.

### SUMMARY OF THE INVENTION

According to a preferred embodiment of the present invention, a method of using Session Initiation Protocol (SIP) to implement voice communications comprises converting inputted voice signals into data conforming to SIP, converting the data conforming to SIP into data conforming to a predetermined protocol, and transmitting the data conforming to the predetermined protocol to a communications means.

According to another preferred embodiment of the present invention, a method of using Session Initiation Protocol (SIP) to implement voice communications comprises receiving data conforming to a predetermined protocol from a communications means, converting the data received from the communications means to data conforming to SIP, and outputting voice signals according to the data conforming to SIP.

According to another preferred embodiment of the present invention, a voice communications system utilizing Session Initiation Protocol (SIP) to implement voice communications comprises a first communications means for communicating with a first remote host with data conforming to a predetermined protocol, and a second communications means for communicating with a second remote host with data conforming to SIP, and for converting data from conforming to the predetermined protocol to conforming to SIP and vice versa.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of employing SIP to implement a voice communications system according to an embodiment of the present invention.

FIG. 2 is a flowchart of the operation of the voice communications system in FIG. 1.

### DETAILED DESCRIPTION

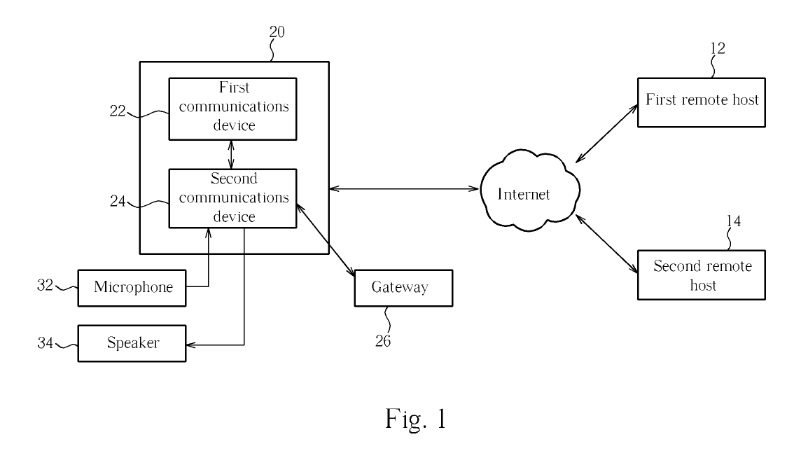

Please refer to FIG. 1. FIG. 1 is a perspective view of employing SIP to implement a voice communications system 20 according to an embodiment of the present invention. The voice communications system 20 comprises a first communications device 22 and a second communications device 24. The first communications device 22 uses data conforming to a predetermined protocol to communicate voice signals with a first remote host 12. The first communications device 22 is an instant messenger such as Skype, MSN messenger, Yahoo Messenger, Google Talk, AIM, ICQ, etc. The instant messenger of the first communications device 22 must be the same as that of the first remote host 12 to enable the voice communications therebetween. For instance, if the instant messenger on the first remote host 12 is Skype, then the instant messenger on the first communications device 22 should also be Skype.

The second communications device 24 uses data consistent with SIP to communicate with a second remote host 14. The second remote host 14 has an instant messenger or a network phone utilizing SIP. When the first and second communications devices 22, 24 use different instant messengers, they can still exchange information because the second communications device 24 is capable of converting data not conforming to SIP into data conforming to SIP and vice versa. Thus the second communications device 24 can exchange voice signals with the first remote host 12 through the first communications device 22.

Further, a network phone utilizing SIP can communicate with the second remote host 14 through a gateway 26. With the data consistent with SIP, the second communications device 24 is able to exchange voice signals with the second remote host 14 through the gateway 26. Because the gateway 26 and the second communications device 24 both utilize SIP, the second communications device 24 can communicate with the second remote host 14 through the gateway 26.

For example, the first communications device 22 is Skype installed on a computer system. The second communications device 24 is SIP installed on the computer system. The voice communications system 20 is coupled to the gateway 26, a microphone 32 and a speaker 34. When SIP is initiated, Skype and the gateway 26 are controlled by SIP, and voice signals inputted to the microphone 32 and voice signals outputted from the speaker 34 are processed by SIP.

Further the microphone 32 and the speaker 34 can be presented by a receiver and a transmitter of a handset of a telephone respectively, or a receiver and a transmitter of a portable phone respectively. If the first remote host 12 uses Skype, the second remote host 14 uses SIP, then a user at the voice communications system 20 can use SIP to communicate with the first remote host 12, and can establish a voice communication with the second remote host 14. Further, through the data conversion of SIP, the user at the first remote host 12 is able to communicate with the user at the second remote host 14. Thus, regardless what communications software or network phone a remote host uses, the remote host is able to establish a voice communication with the voice communications system 20 as long as the voice communications system 20 is installed with SIP and corresponding software.

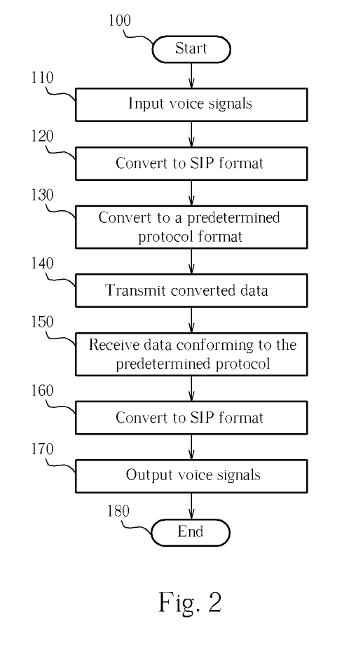

Please refer to FIG. 2. FIG. 2 is a flowchart of the operation of the voice communications system 20 according to the embodiment of the present invention. Step 110 to step 140 describe how the voice communications system 20 processes voice signals to be sent to a remote host. Step 150 to step 170 describe how the voice communications system 20 processes voice signals received from a remote host.

Step 100: initiate the voice communications system 20;

Step 110: input analog voice signals to the microphone 32;

Step 120: the second communications device 24 converts the analog voice signals to data conforming to SIP;

Step 130: the second communications device 24 converts the data conforming to SIP to data conforming to a predetermined protocol of the first communications device 22;

Step 140: the second communications device 24 transmits the data conforming to the predetermined protocol to the first communications device 22; the first communications device 22 transmits the data conforming to the predetermined protocol to the first remote host 12;

Step 150: the first communications device 22 receives data conforming to the predetermined protocol from the first remote host 12;

Step 160: the second communications device 24 receives the data conforming to the predetermined protocol transmitted from the first communications device 22, and converts the data conforming to the predetermined protocol into data conforming to SIP;

Step 170: the second communications device 24 converts the data conforming to SIP to analog voice signals, and drives the speaker 34 to output the analog voice signals;

Step 180: End.

From the above, the voice communications system 20 comprises the first communications device 22 and the second communications device 24. The first communications device 22 uses a predetermined protocol. The second communications device 24 uses SIP and is able to convert data from conforming to the predetermined protocol to conforming to SIP and vice versa. The second communications device 24 can convert inputted analog voice signals into data conforming to SIP, then convert the data conforming to SIP into data conforming to the predetermined protocol, and transmit the data conforming to the predetermined protocol to the first communications device 22. The first communications device 22 can then exchange information with a remote host. And the second communications device 24 can receive data conforming to the predetermined protocol from the first communications device 22, then convert the data conforming to the predetermined protocol into data conforming to SIP. Lastly the data conforming to SIP is converted into analog voice signals which are then output by the speaker 34. Moreover, the second communications device 24 can be used to communicate with a network phone through the gateway 26.

In conclusion, SIP is an important communications protocol. Thus the voice communications system of an embodiment of the present invention uses SIP to integrate voice communications software on a computer system. The voice communications system is compatible with a network phone using SIP. By using a voice communications system with a communications protocol capable of converting data format, a user can communicate with a remote host easily by using the microphone and speaker. Further a voice communication between two remote hosts installed with different protocols can be established through the voice communications system. The voice communications system of the embodiment of the present invention integrates various voice communications services making communications easily feasible.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of using Session Initiation Protocol (SIP) to implement voice communications comprising:
converting inputted voice signals into data conforming to SIP;
converting the data conforming to SIP into data conforming to a predetermined protocol; and
transmitting the data conforming to the predetermined protocol to a communications means.

2. The method of claim 1 further comprising:
receiving data conforming to the predetermined protocol from the communications means;
converting the data received from the communications means to data conforming to SIP; and
outputting voice signals according to the data conforming to SIP converted from the data conforming to the predetermined protocol.

3. The method of claim 1 further comprising establishing a voice communication between the communications means and a remote host.

4. The method of claim 3 wherein establishing the voice communication between the communications means and the remote host is establishing the voice communication between the communications means and the remote host via an internet.

5. A method of using Session Initiation Protocol (SIP) to implement voice communications comprising:
receiving data conforming to a predetermined protocol from a communications means;
converting the data received from the communications means to data conforming to SIP; and
outputting voice signals according to the data conforming to SIP.

6. The method of claim 5 further comprising establishing a voice communication between the communications means and a remote host.

7. The method of claim 6 wherein establishing the voice communication between the communications means and the remote host is establishing the voice communication between the communications means and the remote host via an internet.

8. A voice communications system utilizing Session Initiation Protocol (SIP) to implement voice communications comprising:
a first communications means for communicating with a first remote host with data conforming to a predetermined protocol; and
a second communications means for communicating with a second remote host with data conforming to SIP, and for converting data from conforming to the predetermined protocol to conforming to SIP and vice versa.

9. The system of claim 8 wherein the second communications means is capable of communicating with the first remote host by converting data from conforming to the predetermined protocol to conforming to SIP and vice versa.

10. The system of claim 8 wherein the first communications means is capable of communicating with the second remote host by using the second communications means to convert data from conforming to the predetermined protocol to conforming to SIP and vice versa.

11. The system of claim 8 wherein the first remote host is capable of establishing a voice communication with the second remote host by the first and second communications means.

12. The system of claim 8 wherein the second communications means is capable of using data conforming to SIP to communicate with the second remote host through a gateway installed with SIP.

13. The system of claim 8 wherein the first communications means communicates with the first remote host via an internet.

14. The system of claim 8 wherein the first and second communications means are application software programs installed on a computer system.
